(19) United States
(12) Patent Application Publication
(10) Pub. No.: US 2025/0147517 A1
(43) Pub. Date: May 8, 2025

(54) ROBOTIC STEP TIMING AND SEQUENCING USING REINFORCEMENT LEARNING

(71) Applicant: Boston Dynamics, Inc., Waltham, MA (US)

(72) Inventors: Benjamin John Swilling, Winchester, MA (US); Paul Simon Domanico, Somerville, MA (US)

(21) Appl. No.: 18/931,680

(22) Filed: Oct. 30, 2024

Related U.S. Application Data
(60) Provisional application No. 63/596,024, filed on Nov. 3, 2023.

(51) Int. Cl. G05D 1/622; B62D 57/032; G05D 101/15; G05D 109/12; G06N 3/092

(52) U.S. Cl. CPC G05D 1/622; G06N 3/092; B62D 57/032; G05D 2101/15; G05D 2109/12

(57) ABSTRACT

Techniques for determining robotic step timing and sequencing using reinforcement learning are provided. In one aspect, a method includes receiving a target trajectory for a robot and receiving a state of the robot. The method further includes generating, using a neural network, a set of gait timing parameters for the robot based, at least in part, on the state of the robot and the target trajectory and controlling movement of the robot based on the set of gait timing parameters.

### CROSS-REFERENCE TO RELATED APPLICATION(S)

This application claims the benefit of priority of U.S. Provisional Patent Application No. 63/596,024, filed Nov. 3, 2023, the disclosure of which is hereby incorporated by reference in its entirety herein. Any and all applications for which a foreign or domestic priority claim is identified in the Application Data Sheet as filed with the present application are hereby incorporated by reference under 37 CFR 1.57.

### BACKGROUND

### Technological Field

This disclosure relates to step timing and sequencing for a robot using reinforcement learning.

### Description of the Related Technology

A gait of a legged robot may be viewed as a cyclic pattern of leg movements that produces locomotion through a sequence of foot contacts with a surface. The legs provide support for the body of the legged robot while the forces resulting from surface contact propel the legged robot. Gaits can differ in a variety of ways, and different gaits may produce different styles of locomotion. Selection of an appropriate gait, including the when the legged robot is in a particular state and/or a particular environment, can be challenging, as some gaits might result in the robot becoming unstable or exhibiting undesirable movement.

### SUMMARY OF CERTAIN INVENTIVE ASPECTS

In one aspect there is provided a method comprising: receiving, by a control system of a legged robot, a target trajectory for the legged robot; receiving, by the control system, a state of the legged robot; generating, using a neural network of the control system, a set of gait timing parameters for the legged robot based, at least in part, on the state of the legged robot and the target trajectory; and controlling, by the control system, movement of the legged robot based on the set of gait timing parameters.

In some embodiments, the neural network is trained using reinforcement learning.

In some embodiments, the state of the legged robot includes at least one or more joint angle measurements of the legged robot, one or more pose estimates of the legged robot, and/or a terrain model of the legged robot.

In some embodiments, the gait timing parameters include a contact sequence.

In some embodiments, the contact sequence includes at least one target stepping time.

In some embodiments, the gait timing parameters further include a speed scaling factor.

In some embodiments, the method further comprises: generating, using a model predictive controller (MPC) of the control system, a set of step parameters based on the gait timing parameters, wherein controlling the movement of the legged robot is further based on the set of step parameters.

In some embodiments, the set of step parameters includes at least one of a step placement or a desired center of mass acceleration.

In some embodiments, the method further comprises: initializing the neural network to reproduce the set of step parameters to within a threshold difference of a previous set of step parameters; and training the initialized neural network using reinforcement learning including simulating the MPC to search a space of possible solutions.

In some embodiments, the method further comprises: receiving perception data indicative of an environment of the legged robot; and generating a map of the environment based on the perception data, wherein the neural network further uses the map of the environment as an input.

In some embodiments, the method further comprises: rescaling the trajectory such that movement of the legged robot does not exceed a speed limit while following the trajectory.

In some embodiments, the method further comprises: generating a set of step parameters based on the gait timing parameters and the rescaled trajectory, wherein controlling movement of the legged robot is further based on the set of step parameters.

In some embodiments, the neural network further uses a set of input parameters as inputs, the input parameters comprising one or more of: a terrain height map, a no-step map, a control state, a user-specified desired robot behavior, a body path, or perception data.

In some embodiments, the method further comprises: receiving obstacle data; and generating a body path based on the trajectory and the obstacle data, wherein the neural network further uses the body path as an input.

In another aspect, there is provided a legged robot comprising: a body; two or more legs coupled to the body; one or more sensors configured to measure a state of the legged robot; and a control system in communication with the body and the two or more legs, the control system comprising data processing hardware and memory hardware in communication with the data processing hardware, the memory hardware storing instructions that when executed on the data processing hardware cause the data processing hardware to perform operations comprising: receive a target trajectory for the legged robot; receive the state of the legged robot from the one or more sensors; generate, using a neural network of the control system, a set of gait timing parameters for the legged robot based, at least in part, on the state of the legged robot and the target trajectory; and control movement of the legged robot based on the set of gait timing parameters.

In some embodiments, the neural network is trained using reinforcement learning.

In some embodiments, the state of the legged robot includes at least one or more joint angle measurements of the legged robot, one or more pose estimates of the legged robot, and/or a terrain model of the legged robot.

In some embodiments, the gait timing parameters include a contact sequence.

In some embodiments, the contact sequence includes at least one target stepping time.

In some embodiments, the gait timing parameters further include a speed scaling factor.

In some embodiments, the instructions, when executed on the data processing hardware, further cause the data processing hardware to: generate, using a model predictive controller (MPC) of the control system, a set of step parameters based on the gait timing parameters, wherein controlling the movement of the legged robot is further based on the set of step parameters.

In some embodiments, the set of step parameters includes at least one of a step placement or a desired center of mass acceleration.

In some embodiments, the instructions, when executed on the data processing hardware, further cause the data processing hardware to: initialize the neural network to reproduce the set of step parameters to within a threshold difference of a previous set of step parameters; and train the initialized neural network using reinforcement learning including simulating the MPC to search a space of possible solutions.

In some embodiments, the instructions, when executed on the data processing hardware, further cause the data processing hardware to: receive perception data indicative of an environment of the legged robot; and generate a map of the environment based on the perception data, wherein the neural network further uses the map of the environment as an input.

In some embodiments, the instructions, when executed on the data processing hardware, further cause the data processing hardware to: rescale the trajectory such that movement of the legged robot does not exceed a speed limit while following the trajectory.

In some embodiments, the instructions, when executed on the data processing hardware, further cause the data processing hardware to: generate a set of step parameters based on the gait timing parameters and the rescaled trajectory, wherein controlling movement of the legged robot is further based on the set of step parameters.

In some embodiments, the neural network further uses a set of input parameters as inputs, the input parameters comprising one or more of: a terrain height map, a no-step map, a control state, a user-specified desired robot behavior, a body path, or perception data.

In some embodiments, the instructions, when executed on the data processing hardware, further cause the data processing hardware to: receive obstacle data; and generate a body path based on the trajectory and the obstacle data, wherein the neural network further uses the body path as an input.

In still another aspect, there is provided a non-transitory computer-readable medium having stored therein instructions that, when executed by data processing hardware of a control system, cause the data processing hardware to: receive a target trajectory for a legged robot; receive a state of the legged robot; generate, using a neural network of the control system, a set of gait timing parameters for the legged robot based, at least in part, on the state of the legged robot and the target trajectory; and control movement of the legged robot based on the set of gait timing parameters.

In some embodiments, the neural network is trained using reinforcement learning.

In some embodiments, the state of the legged robot includes at least one or more joint angle measurements of the legged robot, one or more pose estimates of the legged robot, and/or a terrain model of the legged robot.

In some embodiments, the gait timing parameters include a contact sequence.

In some embodiments, the contact sequence includes at least one target stepping time.

In some embodiments, the gait timing parameters further include a speed scaling factor.

In some embodiments, the instructions, when executed by the data processing hardware, further cause the data processing hardware to: generate, using a model predictive controller (MPC) of the control system, a set of step parameters based on the gait timing parameters, wherein controlling the movement of the legged robot is further based on the set of step parameters.

In some embodiments, the set of step parameters includes at least one of a step placement or a desired center of mass acceleration.

In some embodiments, the instructions, when executed on the data processing hardware, further cause the data processing hardware to: initialize the neural network to reproduce the set of step parameters to within a threshold difference of a previous set of step parameters; and train the initialized neural network using reinforcement learning including simulating the MPC to search a space of possible solutions.

In some embodiments, the instructions, when executed on the data processing hardware, further cause the data processing hardware to: receive perception data indicative of an environment of the legged robot; and generate a map of the environment based on the perception data, wherein the neural network further uses the map of the environment as an input.

In some embodiments, the instructions, when executed on the data processing hardware, further cause the data processing hardware to: rescale the trajectory such that movement of the legged robot does not exceed a speed limit while following the trajectory.

In some embodiments, the instructions, when executed on the data processing hardware, further cause the data processing hardware to: generate a set of step parameters based on the gait timing parameters and the rescaled trajectory, wherein controlling movement of the legged robot is further based on the set of step parameters.

In some embodiments, the neural network further uses a set of input parameters as inputs, the input parameters comprising one or more of: a terrain height map, a no-step map, a control state, a user-specified desired robot behavior, a body path, or perception data.

In some embodiments, the instructions, when executed on the data processing hardware, further cause the data processing hardware to: receive obstacle data; and generate a body path based on the trajectory and the obstacle data, wherein the neural network further uses the body path as an input.

### BRIEF DESCRIPTION OF THE DRAWINGS

FIG. 1 is a schematic view of an example robot for navigating a site.

FIG. 2 is a schematic view of a navigation system for navigating the robot of FIG. 1.

FIG. 3 is a block diagram illustrating one example of a gait control system for generating step parameters.

FIG. 4 is a block diagram illustrating one embodiment of a gait control system for generating step parameters using reinforcement learning.

FIG. 5 illustrates an example visualization of perception data generated by one or more sensors of the robot in accordance with aspects of this disclosure.

FIG. 6 illustrates an example visualization of the gait timing parameters generated by the learned parameter selector in accordance with aspects of this disclosure.

FIG. 7 illustrates a method for training the neural network in accordance with aspects of this disclosure.

FIG. 8 illustrates a method for controlling movement of a robot using the trained neural network in accordance with aspects of this disclosure.

FIG. 9 is a schematic view of an example computing device that may be used to implement the systems and methods described herein.

### DETAILED DESCRIPTION

One aspect to ensuring that a robot can traverse various terrains without becoming unstable or exhibiting undesirable movement is the determination of step parameters related to the placement of the robot's feet on the terrain. Depending on the implementation, the step parameters can include the contact sequence, timing, and location for the placement of the robot's feet. As the robot traverses varying terrain, determining a set of step parameters that allow the robot to traverse the terrain without becoming unstable or resulting in otherwise undesirable movement can become increasingly complex. For example, when traversing multi-terrain conditions, it can be difficult to identify step parameters that enable the robot to safely traverse the terrain. Moreover, it may be impractical to anticipate all combinations of terrains that the robot may traverse, and thus, it can be particularly difficult to design algorithms that determine step parameters which are robust under all possible conditions. As described herein, aspects of this disclosure relate to using a learned parameter selector trained using reinforcement learning as part of a gait control system to improve performance under certain conditions, including multifactor terrain, when compared to other implementations.

### Example Robotic Systems

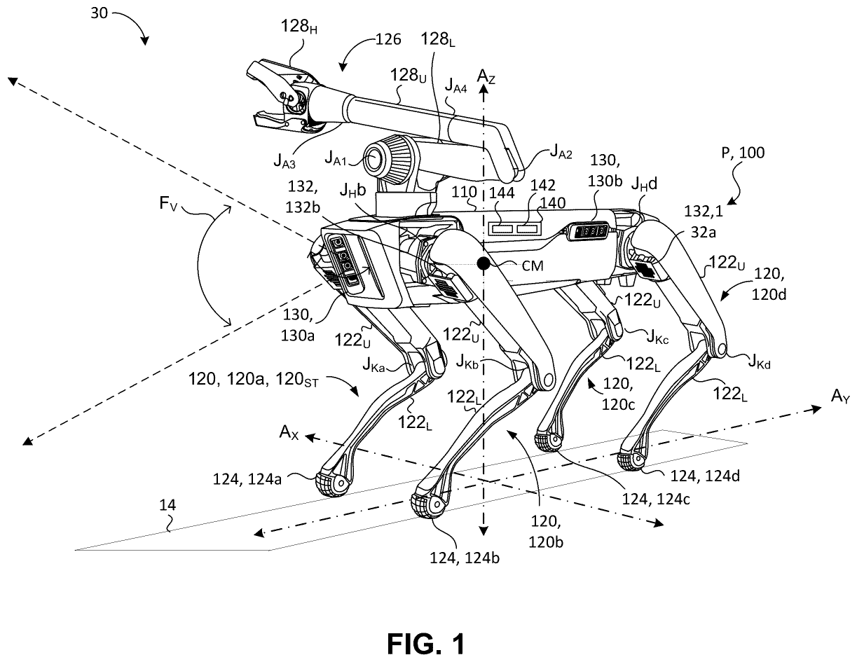

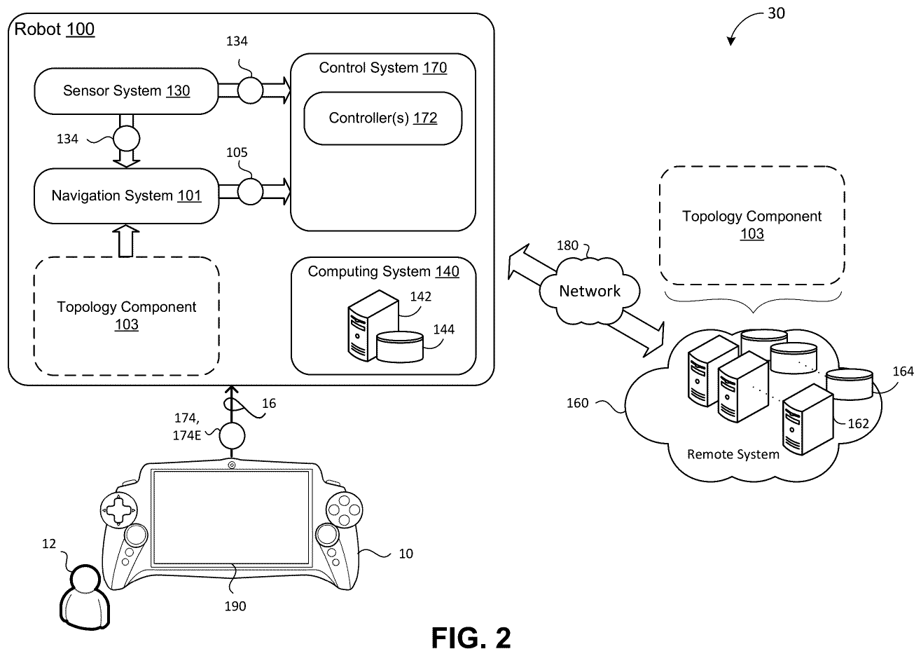

Referring to FIGS. 1 and 2, in some implementations, a robot 100 includes a body 110 with one or more locomotion-based structures such as legs 120a-d coupled to the body 110 that enable the robot 100 to move within a site 30 that surrounds the robot 100. In some examples, all or a portion of the legs 120 are an articulable structure such that one or more joints J permit members 122 of the leg 120 to move. For instance, in the illustrated embodiment, all or a portion of the legs 120 include a hip joint J_{H} coupling an upper member 122, 122_{U} of the leg 120 to the body 110 and a knee joint J_{K} coupling the upper member 122_{U} of the leg 120 to a lower member 122_{L} of the leg 120. Although FIG. 1 depicts a quadruped robot with four legs 120a-d, the robot 100 may include any number of legs or locomotive based structures (e.g., a biped or humanoid robot with two legs, or other arrangements of one or more legs) that provide a means to traverse the terrain within the site 30.

In order to traverse the terrain, all or a portion of the legs 120 may have a distal end 124 that contacts a surface of the terrain (e.g., a traction surface). In other words, the distal end 124 of the leg 120 is the end of the leg 120 used by the robot 100 to pivot, plant, or generally provide traction during movement of the robot 100. For example, the distal end 124 of a leg 120 corresponds to a foot of the robot 100. In some examples, though not shown, the distal end of the leg includes an ankle joint such that the distal end 124 is articulable with respect to the lower member 122_{L} of the leg.

In the examples shown, the robot 100 includes an arm 126 that functions as a robotic manipulator. The arm 126 may move about multiple degrees of freedom in order to engage elements of the site 30 (e.g., objects within the site 30). In some examples, the arm 126 includes one or more members 128, where the members 128 are coupled by joints J such that the arm 126 may pivot or rotate about the joint(s) J. For instance, with more than one member 128, the arm 126 may extend or retract. To illustrate an example, FIG. 1 depicts the arm 126 with three members 128 corresponding to a lower member 128_{L}, an upper member 128_{U}, and a hand member 128_{H} (also referred to as an end-effector). Here, the lower member 128_{L} may rotate or pivot about a first arm joint J_{A1} located adjacent to the body 110 (e.g., where the arm 126 connects to the body 110 of the robot 100). The lower member 128_{L} is coupled to the upper member 128_{U} at a second arm joint J_{A2} and the upper member 128_{U} is coupled to the hand member 128_{H} at a third arm joint J_{A3}. In some examples, such as FIG. 1, the hand member 128_{H} is a mechanical gripper that includes a moveable jaw and a fixed jaw may perform different types of grasping of elements within the site 30. In the example shown, the hand member 128_{H} includes a fixed first jaw and a moveable second jaw that grasps objects by clamping the object between the jaws. The moveable jaw may move relative to the fixed jaw to move between an open position for the gripper and a closed position for the gripper (e.g., closed around an object). In some implementations, the arm 126 additionally includes a fourth joint J_{A4}. The fourth joint J_{A4} may be located near the coupling of the lower member 128_{L} to the upper member 128_{U} and function to allow the upper member 128_{U} to twist or rotate relative to the lower member 128_{L}. In other words, the fourth joint J_{A4} may function as a twist joint similarly to the third joint J_{A3} or wrist joint of the arm 126 adjacent the hand member 128_{H}. For instance, as a twist joint, one member coupled at the joint J may move or rotate relative to another member coupled at the joint J (e.g., a first member coupled at the twist joint is fixed while the second member coupled at the twist joint rotates). In some implementations, the arm 126 connects to the robot 100 at a socket on the body 110 of the robot 100. In some configurations, the socket is configured as a connector such that the arm 126 attaches or detaches from the robot 100 depending on whether the arm 126 is desired for particular operations.

The robot 100 has a vertical gravitational axis (e.g., shown as a Z-direction axis A_{Z}) along a direction of gravity, and a center of mass CM, which is a position that corresponds to an average position of all parts of the robot 100 where the parts are weighted according to their masses (e.g., a point where the weighted relative position of the distributed mass of the robot 100 sums to zero). The robot 100 further has a pose P based on the CM relative to the vertical gravitational axis A_{Z} (e.g., the fixed reference frame with respect to gravity) to define a particular attitude or stance assumed by the robot 100. The attitude of the robot 100 can be defined by an orientation or an angular position of the robot 100 in space. Movement by the legs 120 relative to the body 110 alters the pose P of the robot 100 (e.g., the combination of the position of the CM of the robot and the attitude or orientation of the robot 100). Here, a height generally refers to a distance along the z-direction (e.g., along a z-direction axis A_{Z}). The sagittal plane of the robot 100 corresponds to the Y-Z plane extending in directions of a y-direction axis A_{Y} and the z-direction axis A_{Z}. In other words, the sagittal plane bisects the robot 100 into a left and a right side. Generally perpendicular to the sagittal plane, a ground plane (also referred to as a transverse plane) spans the X-Y plane by extending in directions of the x-direction axis A_{X} and the y-direction axis A_{Y}. The ground plane refers to a ground surface 14 where distal ends 124 of the legs 120 of the robot 100 may generate traction to help the robot 100 move within the site 30. Another anatomical plane of the robot 100 is the frontal plane that extends across the body 110 of the robot 100 (e.g., from a right side of the robot 100 with a first leg 120a to a left side of the robot 100 with a second leg 120b). The frontal plane spans the X-Z plane by extending in directions of the x-direction axis A_{X} and the z-direction axis A_{Z}.

In order to maneuver within the site 30 or to perform tasks using the arm 126, the robot 100 includes a sensor system 130 with one or more sensors 132, 132a-n. For example, FIG. 1 illustrates a first sensor 132, 132a mounted at a head of the robot 100 (near a front portion of the robot 100 adjacent the front legs 120a-b), a second sensor 132, 132b mounted near the hip J_{H}b of the second leg 120b of the robot 100, a third sensor 132, 132c mounted on a side of the body 110 of the robot 100, and a fourth sensor 132, 132d mounted near the hip J_{H}d of the fourth leg 120d of the robot 100. In some cases, the sensor system may include a fifth sensor mounted at or near the hand member 128_{H} of the arm 126 of the robot 100. The sensors 132 may include vision/image sensors, inertial sensors (e.g., an inertial measurement unit (IMU)), force sensors, and/or kinematic sensors. For example, the sensors 132 may include one or more of a camera (e.g., a stereo camera), a time-of-flight (TOF) sensor, a scanning light-detection and ranging (lidar) sensor, or a scanning laser-detection and ranging (ladar) sensor. In some examples, the sensor 132 has corresponding field(s) of view F_{V} defining a sensing range or region corresponding to the sensor 132. For instance, FIG. 1 depicts a field of a view F_{V} for the first sensor 132, 132a of the robot 100. Each sensor 132 may be pivotable and/or rotatable such that the sensor 132, for example, changes the field of view F_{V} about one or more axes (e.g., an x-axis, a y-axis, or a z-axis in relation to a ground plane). In some examples, multiple sensors 132 may be clustered together (e.g., similar to the first sensor 132a) to stitch a larger field of view F_{V} than any single sensor 132. With multiple sensors 132 placed about the robot 100, the sensor system may have a 360 degree view or a nearly 360 degree view of the surroundings of the robot 100 about vertical and/or horizontal axes.

When surveying a field of view F_{V} with a sensor 132, the sensor system generates sensor data 134 (e.g., image data) corresponding to the field of view F_{V} (see, e.g., FIG. 2). The sensor system may generate the field of view F_{V} with a sensor 132 mounted on or near the body 110 of the robot 100 (e.g., sensor(s) 132a, 132c). The sensor system may additionally and/or alternatively generate the field of view F_{V} with a sensor 132 mounted at or near the hand member 128_{H} of the arm 126. The one or more sensors 132 capture the sensor data 134 that defines the three-dimensional point cloud for the area within the site 30 of the robot 100. In some examples, the sensor data 134 is image data that corresponds to a three-dimensional volumetric point cloud generated by a three-dimensional volumetric image sensor 132. Additionally or alternatively, when the robot 100 is maneuvering within the site 30, the sensor system gathers pose data for the robot 100 that includes inertial measurement data (e.g., measured by an IMU). In some examples, the pose data includes kinematic data and/or orientation data about the robot 100, for instance, kinematic data and/or orientation data about joints J or other portions of a leg 120 or arm 126 of the robot 100. With the sensor data 134, various systems of the robot 100 may use the sensor data 134 to define a current state of the robot 100 (e.g., of the kinematics of the robot 100) and/or a current state of the site 30 of the robot 100. In other words, the sensor system may communicate the sensor data 134 from one or more sensors 132 to any other system of the robot 100 in order to assist the functionality of that system.

In some implementations, the sensor system includes sensor(s) 132 coupled to a joint J. Moreover, these sensors 132 may couple to a motor M that operates a joint J of the robot 100 (e.g., sensors 132). Here, these sensors 132 generate joint dynamics in the form of joint-based sensor data 134. Joint dynamics collected as joint-based sensor data 134 may include joint angles (e.g., an upper member 122_{U} relative to a lower member 122_{L} or hand member 126_{H} relative to another member 128 of the arm 126 or robot 100), joint speed, joint angular velocity, joint angular acceleration, and/or forces experienced at a joint J (also referred to as joint forces). Joint-based sensor data generated by one or more sensors 132 may be raw sensor data, data that is further processed to form different types of joint dynamics, or some combination of both. For instance, a sensor 132 measures joint position (or a position of member(s) 122 or 128 coupled at a joint J) and systems of the robot 100 perform further processing to derive velocity and/or acceleration from the positional data. In other examples, a sensor 132 may measure velocity and/or acceleration directly.

With reference to FIG. 2, as the sensor system 130 gathers sensor data 134, a computing system 140 stores, processes, and/or to communicates the sensor data 134 to various systems of the robot 100 (e.g., the control system 170, a navigation system 101, a topology component 103, and/or remote controller 10). In order to perform computing tasks related to the sensor data 134, the computing system 140 of the robot 100 includes data processing hardware 142 and memory hardware 144. The data processing hardware 142 may execute instructions stored in the memory hardware 144 to perform computing tasks related to activities (e.g., movement and/or movement based activities) for the robot 100. Generally speaking, the computing system 140 refers to one or more locations of data processing hardware 142 and/or memory hardware 144.

In some examples, the computing system 140 is a local system located on the robot 100. When located on the robot 100, the computing system 140 may be centralized (e.g., in a single location/area on the robot 100, for example, the body 110 of the robot 100), decentralized (e.g., located at various locations about the robot 100), or a hybrid combination of both (e.g., including a majority of centralized hardware and a minority of decentralized hardware). To illustrate some differences, a decentralized computing system 140 may allow processing to occur at an activity location (e.g., at motor that moves a joint of a leg 120) while a centralized computing system 140 may allow for a central processing hub that communicates to systems located at various positions on the robot 100 (e.g., communicate to the motor that moves the joint of the leg 120).

Additionally or alternatively, the computing system 140 includes computing resources that are located remote from the robot 100. For instance, the computing system 140 communicates via a network 180 with a remote system 160 (e.g., a remote server or a cloud-based environment). Much like the computing system 140, the remote system 160 includes remote computing resources such as remote data processing hardware 162 and remote memory hardware 164. Here, sensor data 134 or other processed data (e.g., data processing locally by the computing system 140) may be stored in the remote system 160 and may be accessible to the computing system 140. In additional examples, the computing system 140 may utilize the remote resources 162, 164 as extensions of the computing resources 142, 144 such that resources of the computing system 140 reside on resources of the remote system 160. In some examples, the topology component 103 is executed on the data processing hardware 142 local to the robot, while in other examples, the topology component 103 is executed on the data processing hardware 162 that is remote from the robot 100.

In some implementations, as shown in FIGS. 1 and 2, the robot 100 includes a control system 170. The control system 170 may communicate with systems of the robot 100, such as the at least one sensor system 130, the navigation system 101, and/or the topology component 103. For example, the navigation system 101 may provide a step plan 105 to the control system 170. The control system 170 may perform operations and other functions using hardware such as the computing system 140. The control system 170 includes at least one controller 172 that may control the robot 100. For example, the controller 172 controls movement of the robot 100 to traverse the site 30 based on input or feedback from the systems of the robot 100 (e.g., the sensor system 130 and/or the control system 170). In additional examples, the controller 172 controls movement between poses and/or behaviors of the robot 100. At least one the controller 172 may be responsible for controlling movement of the arm 126 of the robot 100 in order for the arm 126 to perform various tasks using the hand member 128_{H}. For instance, at least one controller 172 controls the hand member 128_{H} (e.g., a gripper) to manipulate an object or element in the site 30. For example, the controller 172 actuates the movable jaw in a direction towards the fixed jaw to close the gripper. In other examples, the controller 172 actuates the movable jaw in a direction away from the fixed jaw to close the gripper.

A given controller 172 of the control system 170 may control the robot 100 by controlling movement about one or more joints J of the robot 100. In some configurations, the given controller 172 is software or firmware with programming logic that controls at least one joint J or a motor M which operates, or is coupled to, a joint J. A software application (a software resource) may refer to computer software that causes a computing device to perform a task. In some examples, a software application may be referred to as an “application,” an “app,” or a “program.” For instance, the controller 172 controls an amount of force that is applied to a joint J (e.g., torque at a joint J). As programmable controllers 172, the number of joints J that a controller 172 controls is scalable and/or customizable for a particular control purpose. A controller 172 may control a single joint J (e.g., control a torque at a single joint J), multiple joints J, or actuation of one or more members 128 (e.g., actuation of the hand member 128_{H}) of the robot 100. By controlling one or more joints J, actuators or motors M, the controller 172 may coordinate movement for all different parts of the robot 100 (e.g., the body 110, one or more legs 120, the arm 126). For example, to perform a behavior with some movements, a controller 172 may control movement of multiple parts of the robot 100 such as, for example, two legs 120a-b, four legs 120a-d, or two legs 120a-b combined with the arm 126. In some examples, a controller 172 is configured as an object-based controller that is set up to perform a particular behavior or set of behaviors for interacting with an interactable object.

With continued reference to FIG. 2, an operator 12 (also referred to herein as a user or a client) may interact with the robot 100 via the remote controller 10 that communicates with the robot 100 to perform actions. For example, the operator 12 transmits commands 174 to the robot 100 (executed via the control system 170) via a wireless communication network 16. Additionally, the robot 100 may communicate with the remote controller 10 to display an image on a user interface 190 (UI 190) of the remote controller 10. For example, the UI 190 may display the image that corresponds to three-dimensional field of view F_{V} of the one or more sensors 132. The image displayed on the UI 190 of the remote controller 10 is a two-dimensional image that corresponds to the three-dimensional point cloud of sensor data 134 (e.g., field of view F_{V}) for the area within the site 30 of the robot 100. That is, the image displayed on the UI 190 may be a two-dimensional image representation that corresponds to the three-dimensional field of view F_{V} of the one or more sensors 132.

### Techniques for Determining Step Timing and Sequencing for a Legged Robot

One technique for determining step parameters for a legged robot, including step timing and sequencing, involves the use of a gait controller including a model predictive controller (MPC). The MPC can be configured to generate precise specification for contact sequence, timing, and footstep locations which can be used to control the placement of the robot's feet. For example, the MPC can receive a contact sequence and step timing as inputs and generate outputs including precise footstep locations and body control objectives (e.g., accelerations or forces).

Since the step parameters that provide stable movement of the robot without exhibiting undesirable motion can vary greatly depending on the particular terrain the robot is traversing, the control system can include a plurality of different gait controllers each designed to receive a unique set of step parameter inputs (e.g., contact sequence and step timing) for a particular terrain type.

In one example implementation, each of a plurality of MPC-based gait controllers can be specifically designed to generate step parameters for corresponding type of terrain. Each gait controller can be configured (for example, by programming/designing the controller and MPC) using heuristics to generate step parameters for the corresponding type of terrain. Example terrain types that a gait controller may be configured to handle include: stepping over a hurdle, a slippery floor, a flat surface, uneven surfaces, staircases, narrow corridors, etc.

To select an appropriate gait controller, the robot can include a controller selection system used to evaluate the MPC on a discrete set of possible contact sequences and assign a cost to each possibility. Additionally, the controller selection system can evaluate a cost function to select a particular gait controller for use by the robot for a given terrain.

Although such a heuristic-based system can excel in single-terrain scenarios (for instance, stepping over a hurdle or walking over a slippery floor), it can falter in scenarios associated with multiple terrain factors.

Apparatus and methods for robotic step timing and sequencing using reinforcement learning are disclosed herein. In certain embodiments, a legged robot utilizes a neural network trained using reinforcement learning to provide step sequence and speed limiting. For example, the neural network can use various input parameters indicating a measured current state of the robot (for instance, joint angle measurements, pose data, and/or terrain models) to select gait timing parameters and/or speed limits for the robot. In comparison to a hand-coded heuristic-based system, using a learned model can improve the robot's ability to successfully navigate complex multi-factor terrains.

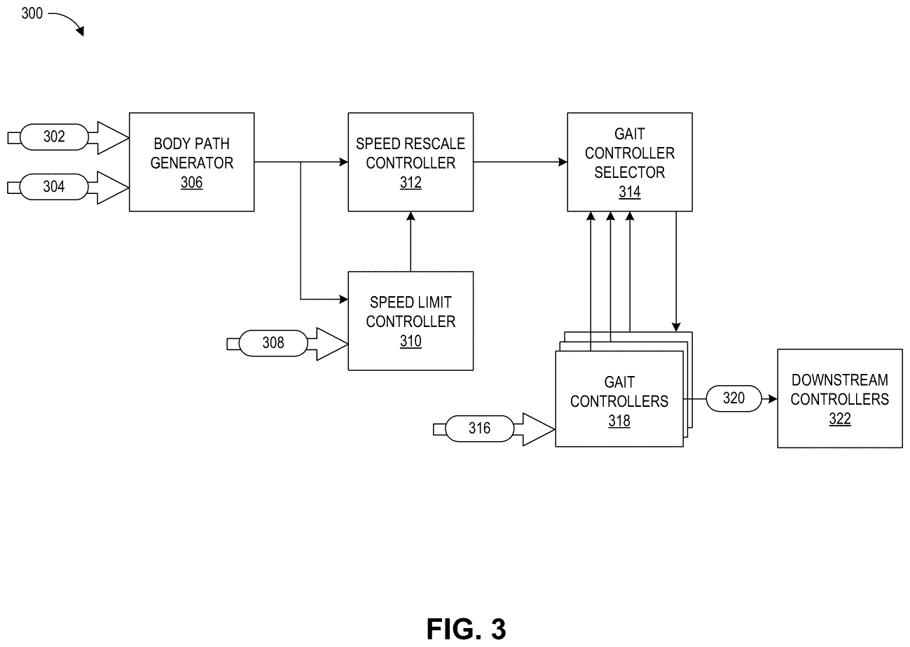

FIG. 3 is a block diagram illustrating one example of a gait control system 300 for generating step parameters. As shown in FIG. 3, the gait control system 300 includes a body path generator 306, a speed rescale controller 312, a speed limit controller 310, a gait controller selector 314, a plurality of gait controllers 318, and one or more downstream controllers 322.

The body path generator 306 is configured to receive a trajectory 302 (also referred to as a target trajectory) and obstacle data 304 as inputs and generate a body path for the body of the robot to follow that avoids the obstacles represented by the obstacle data 304 while at the same time following the trajectory 302. The body path generated by the body path generator 306 is provided to each of the speed rescale controller 312 and the speed limit controller 310.

The speed limit controller 310 is configured to receive the body path along with one or more maps 308 and generate a speed limit for the movement of the robot while following the trajectory 302. The maps 308 can include, for example, the locations of different features within the environment that may affect the robot's ability to traverse the environment. For example, the maps 308 can include: a stair map, a hurdle map, an obstacle map, a no-step region map, a cliff map, etc. In some embodiments, one or more of the maps 308 can be generated based on perception data obtained using one of more of the robot's sensor(s) 132. The perception data can include, for example, terrain height variations, stair models, etc. which can be used to construct at least a portion of one or more of the maps 308. The maps 308 can be included in separate maps, or in other implementations, one of more of the maps 308 may be included in the same map.

The speed limit controller 310 can be configured to generate a speed limit designed to ensure that the robot can remain stable while following the trajectory 302. The speed limit controller 310 is also configured to generate the speed limit such that the robot is able to navigate the features and/or object identified by the maps 308. Depending on the implementation, the speed limit may vary along the trajectory, such that the robot can move more quickly along relatively easier to traverse terrain and slow down when traversing more difficult terrain. In certain embodiments, the speed limit controller 310 can be configured to generate the speed limit based on detecting one or more of the following terrain conditions: stair run and rise, narrow body obstacle corridors, hurdle height, terrain height variation, proximity to a no-step region, and/or proximity to a cliff.

The speed rescale controller 312 is configured to receive the body path and the speed limit and rescale the trajectory, if necessary, such that the rescaled trajectory does not exceed the speed limit. For example, the speed rescale controller 312 can be configured to modify the velocity of the received body trajectory to comply with the speed limit received from the speed limit controller 310. Since the speed limit is generated by the speed limit controller 310 to account for the robot state and perception state, the speed rescale controller 312 can generate the rescaled trajectory to ensure that the robot can robustly traverse any mapped features and/or objects of the environment.

In some embodiments, the body trajectory can be expressed as a series of x/y/yaw points and associated times. While the body path generator 306 is configured to generate the body trajectory as a feasible trajectory for the robot (e.g., the robot body can be in all positions along the trajectory without intersecting with obstacles), the speed rescale controller 312 can improve the reliability of the robot to follow the body trajectory by rescaling the velocity of the trajectory as discussed above.

The gait controller selector 314 is configured to receive the rescaled trajectory and select one of the plurality of gait controllers 318 for generating step parameters based on the trajectory. Each of the gait controllers 318 can be designed with a unique, immutable set of parameters for a corresponding gait (e.g., trot and its properties), and thus, it is desirable to select the gait controller 318 that can best follow the trajectory considering the terrain conditions. For example, the gait controller selector 314 can be configured to evaluate each of the plurality of gait controllers 318 based on generating a possible contact sequence for each of the gait controllers 318. The gait controller selector 314 can assign a cost to each contact sequence and select the gait controller 318 associated with the lowest cost contact sequence.

In one example implementation, the gait controller selector 314 can select one of the gait controllers 318 based on the following process. The gait controller selector 314 can determine a step sequence for each of the gait controllers 318 that would instruct the robot that follow the rescaled trajectory. For example, the gait controller selector 314 can determine a simplified MPC output including the step sequence for each of the gait controllers 318. Since it may be difficult to determine the full MPC output for each the gait controllers 318 at a speed to control the robot in real-time, the simplified MPC outputs can be used as an initial step to select one of the gait controllers 318 for executing the rescaled trajectory.

The gait controller selector 314 can apply a set of costs to each simplified MPC output. Each cost can be applied to a corresponding metric that measures one or more aspects of the corresponding MPC output. Example metrics which can be used to apply costs to the MPC outputs include: a measurement of how far the MPC output steps into a no-step region, a measurement of how extended a leg of the robot is when following the MPC output, a measurement of how far from a nominal timing the MPC output timing parameters are, etc. Once costs have been assigned to each of the MPC outputs, the gait controller selector 314 can select the gait controller 318 associated with the lowest cost simplified MPC output step sequence.

The selected gait controller 318 is configured to generate a set of step parameters 320 for the robot to follow the rescaled trajectory. Such step parameters 320 can include, for example, a desired step placement, a desired center of mass (COM) acceleration, desired force(s) at the center of mass, desired force(s) at the individual actuators, a desired change in momentum, etc. The selected gait controller 318 can receive the rescaled trajectory and a robot state as inputs for generated the set of step parameters 320. The selected gait controller 318 can provide the set of step parameters 320 to the one or more downstream controllers 322 which can then control the robot to follow the set of step parameters 320. Depending on the implementation, the one or more downstream controllers 322 may include, for example, a body planner, a swing planner, a whole body controller, one or more leg controllers, etc.

While the type of gait control system 300 of FIG. 3 can excel when the robot traverses terrain types for which there is a specifically designed gait controller 318, the gait control system 300 may not perform at the same level well when traversing multiple terrain types or terrain types which do not have a corresponding gait controller 318.

Thus, aspects of this disclosure related to gait control systems that incorporate a neural network to improve the performance of the robot when traversing these types of multi-factor terrain conditions.

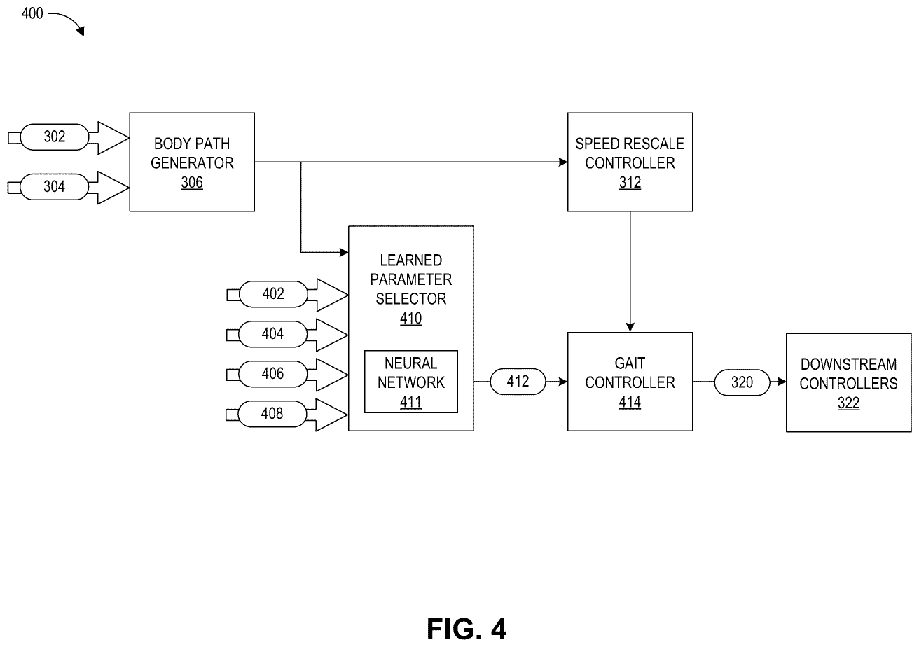

FIG. 4 is a block diagram illustrating one embodiment of a gait control system 400 for generating step parameters using reinforcement learning. With reference to FIG. 4, the gait control system 400 includes a body path generator 306, a speed limit controller 310, a learned parameter selector 410, a gait controller 414, and one or more downstream controllers 322. In comparison to the gait control system 300 of FIG. 3, the gait control system 400 includes the learned parameter selector 410 to replace one or more of the speed limit controller 310 and gait controller selector 314. In addition, the gait control system 400 can include a single gait controller 414 that replaces the plurality of gait controllers 318 from the gait control system 300. However, aspects of this disclosure are not limited thereto and the gait control system 400 can include a plurality of gait controllers 414 in other implementations. Depending on the embodiment, the gait controller 414 can include an MPC controller configured to generate the set of step parameters 320 that follow the rescaled trajectory based on a set of gait timing parameters 412 received from the learned parameter selector 410.

The learned parameter selector 410 is configured to receive the body path from the body path generator 306 as well as one or more other input parameters, such as a terrain height map 402, a no-step map 404, a robot state 406, and/or a control state (or phase) 408. In some embodiments, the robot state 406 can include: joint angle measurements, pose estimates, terrain models, etc. of the robot. In addition to a current state of the robot, the robot state 406 can also include previous states in some embodiments.

The learned parameter selector 410 is configured to generate the gait timing parameters 412 based on the body path and the input parameter(s). In some embodiments, the gait timing parameters 412 can include step sequence and speed limiting parameters, which can be used by the gait controller 414 to generate the set of step parameters 320. In some embodiments, the gait timing parameters 412 can include: a desired stepping time, a desired stepping time for N future stances, a speed scaling multiplier, and a series of future contact states.

In some embodiments, the learned parameter selector 410 includes a neural network 411 trained using reinforcement learning. As described herein, by using a learned parameter selector 410 trained using reinforcement learning, the gait control system 400 is able to improve performance under certain conditions, including multifactor terrain, when compared to other implementations.

Depending on the embodiment, the learned parameter selector 410 can receive a variety of different input parameters which can be used to generate the gait timing parameters 412. These input parameters can include: the terrain height map 402, the no-step map 404, the robot state 406, the control state 408, a user-specified desired robot behavior, the trajectory 302, the body path, and/or perception information. In some embodiments, the user-specified desired robot behavior can include user-defined constraints that limit the types of movement that can be performed by the robot. The perception information can include, for example, perception data, distance to foot obstacles, distance to body obstacles, etc.

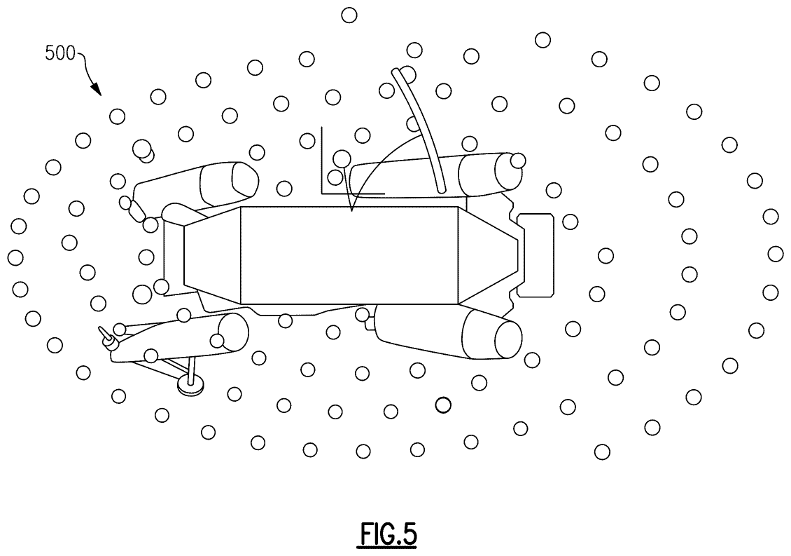

FIG. 5 illustrates an example visualization of perception data 500 generated by one or more sensors 132 of the robot in accordance with aspects of this disclosure. As shown in FIG. 5, the perception data can be compiled to generate one or more maps that represent features of and/or objects within the environment of the robot.

As described above, the learned parameter selector 410 is configured to generate gait timing parameters 412 based on the received input parameters. In some examples, the gait timing parameters 412 include modifications to the trajectory speed and/or contact sequence.

In the case that the gait timing parameters 412 define step sequencing and/or timing with respect to a particular gait (for instance, a trot gait) and the modifications can include modifying the timing parameters of the particular gait. In other implementations, the gait timing parameters 412 can generate more general gait timing parameters 412 including modifications to the sequence and/or contact time for any gait type. In some embodiments, the gait timing parameters 412 can also include adjustments to the desired body position and/or speed.

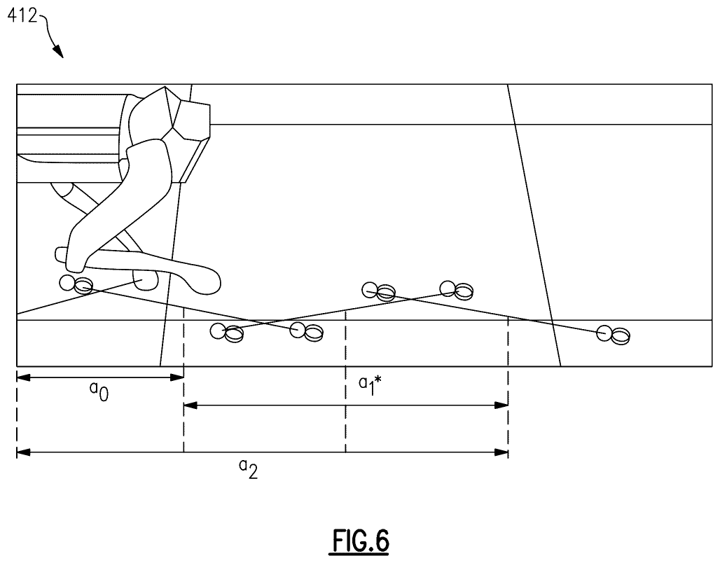

Because the gait timing parameters 412 generated by the learned parameter selector 410 can define the properties of a particular gait for the robot to perform, the gait controller 414 can be designed to be agnostic to the gait. That is, the gait controller 414 does not need to be assigned to a set of parameters associated with a unique gait because the gait timing parameters 412 provided to the gait controller 414 can include sufficient information to define the gait. [0054] FIG. 6 illustrates an example visualization of the gait timing parameters 412 generated by the learned parameter selector 410 in accordance with aspects of this disclosure. As shown in FIG. 6, the gait timing parameters 412 can include modifications to the timing of the contact sequence and/or trajectory speed.

The gait controller 414 of FIG. 4 is configured to generate the set of step parameters 320 based on the rescaled trajectory received from the speed limit controller 310 and the gait timing parameters 412 received from the learned parameter selector 410. In some embodiments, because the gait controller 414 receives the gait timing parameters 412 from the learned parameter selector 410, a single gait controller 414 can be used to generate the set of step parameters 320. In other words, because the gait controller 414 can generate set of step parameters 320 for various different terrain types, including multi-terrain conditions, the gait control system 400 can be implemented without separate gait controllers 318 designed to handle different terrain types. Thus, the gait controller 414 can be considered a continuous gait controller that can generate set of step parameters 320 for substantially the entire continuum of possible gaits.

The neural network 411 can be trained to improve the robot's ability to traverse terrain conditions which the robot may not have been specifically programmed to traverse. For example, the gait control system 300 of FIG. 3 includes plurality of gait controllers 318, each of which may be programmed to generate set of step parameters 320 which enable the robot to traverse a specific terrain condition. One limitation to this implementation is that the robot may have a lower rate of success when traversing terrain conditions that do not have a corresponding gait controller 318. In some implementations, the rate of success can be measured by the stability of the robot and/or whether the robot violates one or more user-defined constraints.

In contrast, the neural network 411 can be trained to mimic the behavior of the gait controllers 318 while also being trained to handle other and/or unexpected terrain types. For example, the neural network 411 can be trained generate set of step parameters 320 that are substantially similar to the set of step parameters 320 generated by the plurality of gait controllers 318 when the same set of input parameters to the neural network 411 and the gait controllers 318.

In some embodiments, the neural network 411 can be trained using reinforcement learning techniques. Advantageously, reinforcement learning does not require labelling input/output data, but rather reinforcement learning can be used to search or explore the space of possible solutions to find weights of the neural network that best match one or more goals (e.g., stability and/or user-specified desired robot behavior). In some embodiments, the reinforcement learning can include randomly searching or exploring the space of possible solutions. Due to the number of degrees-of-freedom for movement of the robot through the environment, the space of possible solutions may be a relatively high-dimensional space.

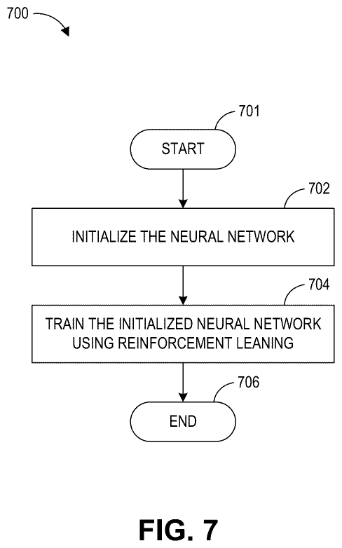

FIG. 7 illustrates a method 700 for training the neural network 411 in accordance with aspects of this disclosure. One or more blocks of the method 700 may be implemented, for example, by data processing hardware configured for training the neural network 411. In some embodiments, the data processing hardware may be a special purpose processor, such as a graphics processing unit (GPU) or other data processing hardware designed for training neural networks. The method 700 begins at block 701.

As shown in FIG. 7, the method 700 involves training the neural network 411 using at least two separate training steps illustrated by blocks 702 and 704. At block 702, the data processing hardware can initialize the neural network 411 to generate sets of step parameters 320 that are substantially similar to the sets of step parameters 320 generated by the plurality of gait controllers 318 for the gait control system 300. For example, the data processing hardware may initialize the neural network 411 such that the sets of step parameters 320 generated by the neural network 411 are within a threshold difference of the sets of step parameters 320 generated by the plurality of gait controllers 318 of a model gait control system (e.g., a previously designed gait control system 300). In some embodiments, initializing the neural network 411 may include training the neural network 411 in order to reproduce the set of step parameters 320 generated by the plurality of gait controllers 318 to within a threshold level of deviation. In some embodiments, the data processing hardware may initialize the neural network 411 by minimizing the difference between the sets of step parameters 320 generated by the neural network 411 and the sets of step parameters 320 generated by the plurality of gait controllers 318.

In some embodiments, initializing the neural network 411 can involve using a cloning method (also referred to as “behavior cloning,” “imitation learning,” or “knowledge distillation”) to mimic the plurality of gait controllers 318. In some embodiments, the cloning method can include the DAgger algorithm (Dataset Aggregation), although other cloning methods are also possible. In certain embodiments, initializing the neural network 411 can include using physics simulation to generate a large, diverse set of data demonstrating the gait parameters that the previously designed gait control system 300 for a given simulated robot state. The weights of the initialized neural network 411 can be adjusted to minimize output error over the simulated set of data. The initialization of the neural network 411 can be performed in order to mimic each of the plurality of plurality of gait controllers 318. While initializing the neural network 411 using a cloning method may have certain advantages as described above, aspects of this disclosure are not limited to using cloning techniques. For example, in some embodiments the data processing hardware can randomly initialize the neural network 411, which can also produce good results after the reinforcement learning of block 704.

At block 704, the data processing hardware can train the initialized neural network 411 using reinforcement learning. In some embodiments, the data processing hardware may also partially randomize the neural network 411 prior to performing reinforcement learning. The data processing hardware can modify the neural network 411 using on-policy reinforcement learning by, for example, running the MPC controller of the gait controller 414 a plurality of times in simulation. In certain embodiment, simulating the MPC controller can include randomly exploring the space of possible solutions. Each simulation can generate a set of set of step parameters 320 and the data processing hardware can evaluate the simulated set of step parameters 320 against one or more costs to determine the performance of the simulation. The costs can include, for example, a measurement of the stability of the robot and a measurement of whether the step parameters 320 violate one or more constraints related to desired robot behavior. For example, the one or more constraints related to desired robot behavior may be user-defined constraints that limit the types of movement that are performed by the robot. The data processing hardware can adjust weights of the neural network 411 based on the simulated set of step parameters 320 and the corresponding evaluation of the performance of the simulated step parameters 320.

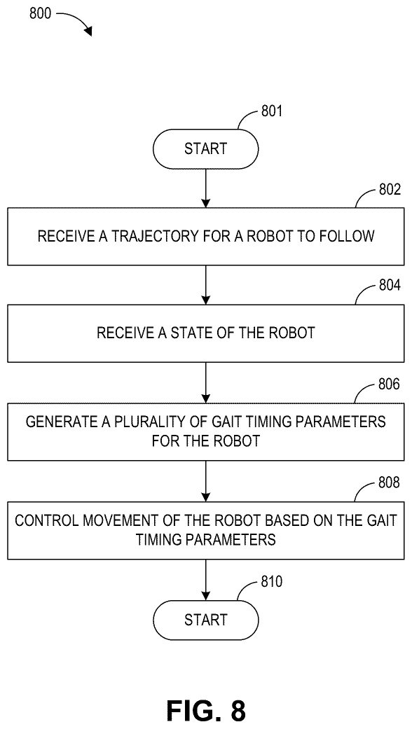

FIG. 8 illustrates a method 800 for controlling movement of a robot using the trained neural network 411 in accordance with aspects of this disclosure. One or more blocks of the method 800 may be implemented, for example, by the data processing hardware 142 of the computing system 140 of the robot 100 of FIG. 1, or any other data processing hardware of a robot. The method 800 begins at block 801.

At block 802, the data processing hardware 142 receives a trajectory for a robot to follow. The trajectory may correspond to the trajectory 302 of FIG. 4. In one example, the data processing hardware 142 can generate a body path for a body of the robot to follow that avoids objects in the environment when traversing the environment according to the trajectory.

At block 804, the data processing hardware 142 receives a state of the robot (such as the robot state 406 illustrated in FIG. 4). In some embodiments, the data processing hardware 142 executes a learned parameter selector 410 which uses the robot state 406 and the body path as inputs. As shown in FIG. 4, the learned parameter selector 410 can also receive additional inputs, such as the terrain height map 402, the no-step map 404, and/or the control state 408, among other possible inputs.

At block 806, the data processing hardware 142 generates, using a neural network (such as the neural network 411 of FIG. 4), a plurality of gait timing parameters (such as the gait timing parameters 412 of FIG. 4) for the robot using the state of the robot and the trajectory as inputs to the neural network. The neural network 411 can be included as part of the learned parameter selector 410 in some implementations. In certain embodiments, the neural network 411 can be trained, for example, by the method 700 described in connection with FIG. 7.

At block 808, the data processing hardware 142 controls movement of the robot based on the gait timing parameters. In some embodiments, the data processing hardware 142 may use a gait controller 414 to generate set of step parameters 320 based on the gait timing parameters 412. The data processing hardware 142 may also implement one or more downstream controllers 322 configured to control movement of the robot based on the set of step parameters 320. The method 800 ends at block 810.

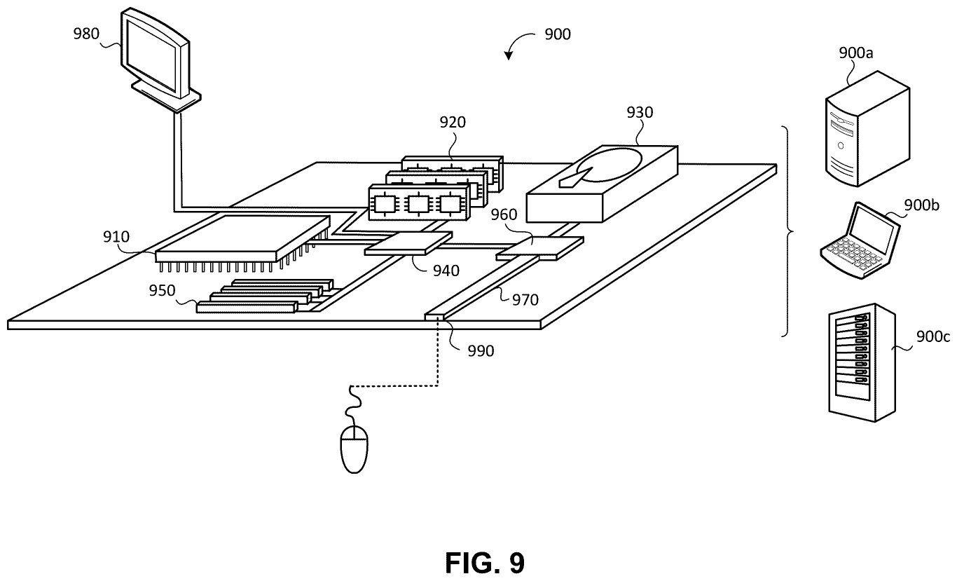

FIG. 9 is a schematic view of an example computing device 900 that may be used to implement the systems and methods described in this document. The computing device 900 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 900 includes a processor 910, memory 920, a storage device 930, a high-speed interface/controller 940 connecting to the memory 920 and high-speed expansion ports 950, and a low-speed interface/controller 960 connecting to a low-speed bus 970 and a storage device 930. Each of the components 910, 920, 930, 940, 950, and 960, are interconnected using various busses, and may be mounted on a common motherboard or in other manners as appropriate. The processor 910 can process instructions for execution within the computing device 900, including instructions stored in the memory 920 or on the storage device 930 to display graphical information for a graphical user interface (GUI) on an external input/output device, such as display 980 coupled to high-speed interface 940. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 920 stores information non-transitorily within the computing device 900. The memory 920 may be a computer-readable medium, a volatile memory unit(s), or non-volatile memory unit(s). The non-transitory memory 920 may be physical devices used to store programs (e.g., sequences of instructions) or data (e.g., program state information) on a temporary or permanent basis for use by the computing device 900. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 930 is capable of providing mass storage for the computing device 900. In some implementations, the storage device 930 is a computer-readable medium. In various different implementations, the storage device 930 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 920, the storage device 930, or memory on processor 910.

The high-speed controller 940 manages bandwidth-intensive operations for the computing device 900, while the low-speed controller 960 manages lower bandwidth-intensive operations. Such allocation of duties is exemplary only. In some implementations, the high-speed controller 940 is coupled to the memory 920, the display 980 (e.g., through a graphics processor or accelerator), and to the high-speed expansion ports 950, which may accept various expansion cards (not shown). In some implementations, the low-speed controller 960 is coupled to the storage device 930 and a low-speed expansion port 990. The low-speed expansion port 990, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 900aor multiple times in a group of such servers 900a, as a laptop computer 900b, or as part of a rack server system 900c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. A processor can receive instructions and data from a read only memory or a random-access memory or both. The essential elements of a computer are a processor for performing instructions and one or more memory devices for storing instructions and data. A computer can include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A method, comprising:
receiving, by a control system of a legged robot, a target trajectory for the legged robot;
receiving, by the control system, a state of the legged robot;
generating, using a neural network of the control system, a set of gait timing parameters for the legged robot based, at least in part, on the state of the legged robot and the target trajectory; and
controlling, by the control system, movement of the legged robot based on the set of gait timing parameters.

2. The method of claim 1, wherein the neural network is trained using reinforcement learning.

3. The method of claim 1, wherein the gait timing parameters include a contact sequence.

4. The method of claim 3, wherein the contact sequence includes at least one target stepping time.

5. The method of claim 3, wherein the gait timing parameters further include a speed scaling factor.

6. The method of claim 1, further comprising:
generating, using a model predictive controller (MPC) of the control system, a set of step parameters based on the gait timing parameters,
wherein controlling the movement of the legged robot is further based on the set of step parameters.

7. The method of claim 6, wherein the set of step parameters includes at least one of a step placement or a desired center of mass acceleration.

8. The method of claim 6, further comprising:
initializing the neural network to reproduce the set of step parameters to within a threshold difference of a previous set of step parameters; and
training the initialized neural network using reinforcement learning including simulating the MPC to search a space of possible solutions.

9. The method of claim 1, further comprising:
receiving perception data indicative of an environment of the legged robot; and
generating a map of the environment based on the perception data,
wherein the neural network further uses the map of the environment as an input.

10. The method of claim 1, wherein the neural network further uses a set of input parameters as inputs, the input parameters comprising one or more of: a terrain height map, a no-step map, a control state, a user-specified desired robot behavior, a body path, or perception data.

11. The method of claim 1, further comprising:
receiving obstacle data; and
generating a body path based on the trajectory and the obstacle data,
wherein the neural network further uses the body path as an input.

12. A legged robot comprising:
a body;
two or more legs coupled to the body;
one or more sensors configured to measure a state of the legged robot; and
a control system in communication with the body and the two or more legs, the control system comprising data processing hardware and memory hardware in communication with the data processing hardware, the memory hardware storing instructions that when executed on the data processing hardware cause the data processing hardware to:
receive a target trajectory for the legged robot;
receive the state of the legged robot from the one or more sensors;
generate, using a neural network of the control system, a set of gait timing parameters for the legged robot based, at least in part, on the state of the legged robot and the target trajectory; and
control movement of the legged robot based on the set of gait timing parameters.

13. The legged robot of claim 12, wherein the neural network is trained using reinforcement learning.

14. The legged robot of claim 12, wherein the gait timing parameters include a contact sequence.

15. The legged robot of claim 12, wherein the instructions, when executed on the data processing hardware, further cause the data processing hardware to:
generate, using a model predictive controller (MPC) of the control system, a set of step parameters based on the gait timing parameters,
wherein controlling the movement of the legged robot is further based on the set of step parameters.

16. The legged robot of claim 15, wherein the set of step parameters includes at least one of a step placement or a desired center of mass acceleration.

17. The legged robot of claim 15, wherein the instructions, when executed on the data processing hardware, further cause the data processing hardware to:
initialize the neural network to reproduce the set of step parameters to within a threshold difference of a previous set of step parameters; and
train the initialized neural network using reinforcement learning including simulating the MPC to search a space of possible solutions.

18. The legged robot of claim 12, wherein the instructions, when executed on the data processing hardware, further cause the data processing hardware to:
receive perception data indicative of an environment of the legged robot; and
generate a map of the environment based on the perception data,
wherein the neural network further uses the map of the environment as an input.

19. A non-transitory computer-readable medium having stored therein instructions that, when executed by data processing hardware of a control system, cause the data processing hardware to:
receive a target trajectory for a legged robot;
receive a state of the legged robot;
generate, using a neural network of the control system, a set of gait timing parameters for the legged robot based, at least in part, on the state of the legged robot and the target trajectory; and
control movement of the legged robot based on the set of gait timing parameters.

20. The non-transitory computer-readable medium of claim 19, wherein the neural network is trained using reinforcement learning.
